(19) United States
(12) Patent Application Publication
(10) Pub. No.: US 2007/0215581 A1
(43) Pub. Date: Sep. 20, 2007

(54) LASER BEAM MACHINING METHOD AND LASER BEAM MACHINING APPARATUS

(76) Inventors: Hirokazu Kato, Suntoh-gun (JP); Satoru Higano, Naka-shi (JP)

Correspondence Address: DARBY & DARBY P.C., P.O. BOX 770, Church Street Station, New York, NY, 10008-0770, US

(21) Appl. No.: 11/576,100

(22) PCT Filed: Sep. 29, 2005
(86) PCT No.: PCT/JP05/17943

§ 371 Date: Mar. 27, 2007

(30) Foreign Application Priority Data
Sep. 27, 2004 (JP) 2004-283454
Sep. 21, 2005 (JP) 2005-274157

(51) Int. Cl. B23K 26/38; B23K 26/40

(52) U.S. Cl. 219/121.69

(57) ABSTRACT

In a laser beam machining method and a laser beam machining apparatus, a higher improvement in machining ability is required for grooving and cutting of a semiconducting material or a ceramic material. In order to meet this requirement, the invention provides a laser beam machining apparatus and a laser beam machining method in which an ultraviolet laser beam is irradiated in pulses onto a workpiece made of an inorganic material to groove or cut the workpiece. In this laser beam machining apparatus and laser beam machining method, as the scanning speed of the ultraviolet laser beam is higher, or as the machining depth of the grooving or the cutting is greater, the pulse width of the ultraviolet laser beam is set to be greater. This can significantly improve the machining ability compared with a case where the average power is increased.

### CROSS REFERENCE TO PRIOR APPLICATIONS

This is a U.S. national phase application under 35 U.S.C. § 371 of International Patent Application No. PCT/JP2005/017943 filed Sep. 29, 2005, and claims the benefit of Japanese Applications No. 2004-283454 filed Sep. 29, 2004 and 2005-274157 filed Sep. 21, 2005 all of which are incorporated by reference herein. The International Application was published in Japanese on Apr. 6, 2006 as International Publication No. WO 2006/035870 under PCT Article 21 (2).

### TECHNICAL FIELD

The present invention relates to a laser beam machining method and a laser beam machining apparatus which are suitable for grooving or cutting of a semiconducting material, a ceramic material, etc.

### BACKGROUND ART

In recent years, a laser beam machining technique using a ultraviolet-ray laser capable of high-precision machining is adopted for grooving (scribing) and cutting of resin substrates, metallic plates, ceramics plates, and semiconductor wafers.

In this laser beam machining technique, in order to improve the machining ability of grooving, etc., there is conventionally shown the data that it is important how many pulses of a laser beam are driven into the same spot, and it is effective to enhance the average power of an ultraviolet laser beam, fluence, peak power, etc.

For example, Japanese Unexamined Patent Application, First Publication No. 2003-266709 (Paragraph No. 0028) suggests a technique of irradiating a laser beam having a high peak power onto the same spot for plural times for removal of a metallic film formed on PZT ceramics in manufacturing an ink jet head. In this technique, it is believed that, when the metallic film is evaporated and vaporized, it is preferable to perform energy irradiation with high peak power and short pulse width.

The following problem is left unsolved in the above conventional technique.

In the above conventional laser beam machining technique, when grooving and cutting, are performed on, for example, a semiconducting material, such as a silicon substrate, and a ceramic material, such as an alumina substrate, measures, such as increasing the average power, peak power, etc. are taken in order to improve the machining ability. However, it was difficult to improve the machining ability significantly compared with cases where an organic material, such as a resin material, and metals, are machined.

The invention has been made in consideration of the above-mentioned problem, and it is therefore an object of the invention to provide a laser beam machining method and a laser beam machining apparatus capable of further improving the machining ability in grooving and cutting of a semiconducting material or a ceramic material.

The present inventors have advanced investigations about the grooving and cutting by laser beam machining of a semiconducting material or a ceramic material, and consequently found out that the machining ability is greatly dependent on the pulse width rather than the magnitude of the average power.

The invention has adopted the following configurations on the basis of the above knowledge in order to solve the problem. That is, the present invention provides a laser beam machining method of irradiating an ultraviolet laser beam in pulses onto a workpiece made of an inorganic material to groove or cut the workpiece, wherein a pulse width of the ultraviolet laser beam is set to be greater as the scanning speed of the ultraviolet laser beam is higher, or as the machining depth of the grooving or the cutting is greater.

Furthermore, the present invention provides a laser beam machining apparatus for irradiating an ultraviolet laser beam in pulses onto a workpiece made of an inorganic material to groove or cut the workpiece, the apparatus including: a laser light source unit which outputs the ultraviolet laser beam; an optical system which focuses the ultraviolet laser beam to irradiate the workpiece with the ultraviolet laser beam; a moving mechanism which relatively moves the ultraviolet laser beam to move a irradiation position in the workpiece; and a control unit which controls the laser light source unit, the optical system, and the moving mechanism, respectively, wherein the control unit set the pulse width of the ultraviolet laser beam to be long, as the scanning speed of the ultraviolet laser beam is higher, or as the machining depth of the grooving or the cutting is greater.

That is, in these laser beam machining method and laser beam machining apparatus, as the machining depth is greater or as the scanning speed is higher, by setting the pulse width of an ultraviolet laser beam greater, the machining ability can be significantly improved compared with a case where the average power is increased.

Furthermore, in the laser beam machining method of the invention, the pulse width of the ultraviolet laser beam may be set to 15 nsec or greater.

Furthermore, in the laser beam machining apparatus of the invention, the pulse width of the ultraviolet laser beam may be set to 15 nsec or greater.

That is, if the pulse width of an ultraviolet laser beam is less than 15 nsec, the machining ability cannot be improved sufficiently. However, in the laser beam machining method and laser beam machining apparatus of the invention, the machining ability can be improved sufficiently even in the same average power by setting the pulse width of an ultraviolet laser beam to at least 15 nsec or greater.

Moreover, in the laser beam machining method of the invention, the peak power density of the ultraviolet laser beam may be set to 0.8 GW/cm² or less.

Moreover, in the laser beam machining apparatus of the invention, the control unit may set the peak power density of the ultraviolet laser beam to 0.8 GW/cm² or less.

That is, in the laser beam machining method and laser beam machining apparatus of the invention, significant degradation of the cutting ability can be prevented by setting the peak power density of the ultraviolet laser beam to 0.8 GW/cm² or less.

Furthermore, in the laser beam machining method of the invention, the ultraviolet laser beam may be a harmonic laser beam whose wavelength is converted by causing a fundamental wave laser beam to enter a wavelength converting element made of a nonlinear optical crystal.

Furthermore, in the laser beam machining apparatus of the invention, the ultraviolet laser beam may be a harmonic laser beam whose wavelength is converted by causing a fundamental wave laser beam to enter a wavelength converting element made of a nonlinear optical crystal.

That is, in the laser beam machining method and the laser beam machining apparatus, the harmonic laser beam is used in the wavelength converting element. Thus, a high-energy and short-wavelength laser beam can be stably radiated by a small apparatus.

Furthermore, in the laser beam machining method of the invention, the ultraviolet laser beam may be generated by a solid-state laser, and may have a wavelength of 400 nm or less.

Furthermore, in the laser beam machining apparatus of the invention, the ultraviolet laser beam may be generated by a solid-state laser, and may have a wavelength of 400 nm or less.

Furthermore, in the laser beam machining method of the invention, at least Li₂B₄O₇ may be used for the nonlinear optical crystal.

Furthermore, in the laser beam machining apparatus of the invention, at least Li₂B₄O₇ may be used for the nonlinear optical crystal.

According to the invention, the following effects are achieved.

That is, according to the laser beam machining method and laser beam machining apparatus related to the invention, in grooving and cutting a semiconducting material or a ceramic material, as the machining depth is greater or as the scanning speed is higher, the pulse width of an ultraviolet laser beam is set to be greater. As a result, the machining ability can be significantly improved compared with a case where the average power is increased. Accordingly, deep machining can be efficiently performed even in these materials by virtue of high machining ability, and the scanning speed of a laser beam can be enhanced. As a result, the machining productivity can be improved considerably.

### BRIEF DESCRIPTION OF THE DRAWINGS

FIG. 1 is a schematic block diagram showing a laser beam machining apparatus used in a laser beam machining method of one embodiment according to the invention.

FIG. 2 is a graph showing the groove depth with respect to the scanning speed in a case where the pulse width and the average power are varied, in an example according to the invention.

FIG. 3 is a graph showing the scanning speed at which a workpiece can be machined to a constant groove depth with respect to the total dose and the pulse width, in an example according to the invention.

FIGS. 4A to 4C are graphs showing the results obtained by analyzing the relationship between the total dose and the groove depth of a groove to be machined in the Examples according to the invention, in particular FIGS. 4A, 4B, and 4C show the cases in which the scanning speeds are 10 mm/s (a), 50 mm/s (b), and 100 mm/s (c), respectively.

FIGS. 5A to 5C are graphs showing the results obtained by analyzing the relationship between the pulse width and the groove depth in the Examples according to the invention, in particular, FIGS. 5A, 5B and 5C show the cases in which the scanning speeds are 10 mm/s (a), 50 mm/s (b), and 100 mm/s (c), respectively.

FIGS. 6A to 6C are graphs showing the results obtained by analyzing the relationship between the pulse width and the cutting ability in the Examples according to the invention, in particular, FIGS. 6A, 6B, and 6C show the cases in which the scanning speeds are 10 mm/s (a), 50 mm/s (b), and 100 mm/s (c), respectively.

FIGS. 7A to 7C are graphs showing the results obtained by analyzing the relationship between the power peak density and the cutting ability in the Examples according to the invention, in particular, FIGS. 7A, 7B, and 7C show the cases in which the scanning speeds are 10 mm/s (a), 50 mm/s (b), and 100 mm/s (c), respectively.

### DETAILED DESCRIPTION OF THE INVENTION

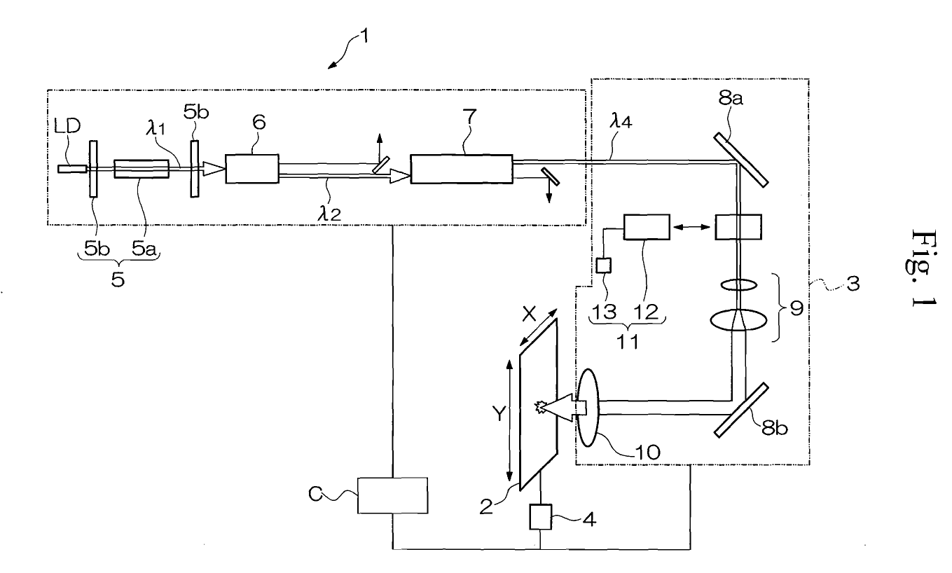

Hereinafter, an embodiment of a laser beam machining method and a laser beam machining apparatus according to the invention will be described, referring to FIG. 1.

The laser beam machining method of the present embodiment, which is a method that performs grooving (scribing) on an inorganic material, such as an alumina substrate, with UV (ultraviolet) laser light, is performed using the following laser beam machining apparatus of the invention. This laser beam machining apparatus, as shown in FIG. 1, includes a laser head unit (laser light source unit) 1 which outputs a quadruple wave laser beam λ₄ of ultraviolet light (with a wavelength of 266 nm), an optical system 3 which focuses the quadruple wave laser beam λ₄ to irradiate a workpiece 2, such as an alumina substrate, a moving mechanism 4 which can relatively move the quadruple wave laser beam λ₄ to move a irradiation position in the workpiece 2, and change the direction of movement of the quadruple wave laser beam λ₄, and a control unit C which controls the laser head unit 1, the optical system 3, and the moving mechanism 4, respectively.

The laser head unit 1 includes a semiconductor laser LD which emits excitation light with a wavelength of 810 nm, a YAG laser 5 which emits a fundamental wave laser beam λ₁ with a wavelength of 1064 nm pumped by the excitation light, a first wavelength converting element 6 which converts the fundamental wave laser beam λ₁ inside into a double wave laser beam (harmonic laser beam) λ₂ with a wavelength of 532 nm (green light), which is a second harmonic wave, to output it, and a second wavelength converting element 7 which converts the double wave laser beam λ₂ inside to a quadruple wave laser beam (harmonic laser beam) λ₄ with a wavelength of 266 nm (ultraviolet light), which is a second harmonic wave, to output it.

The YAG laser 5 includes an Nd:YAG crystal 5a and resonator mirrors 5b disposed at both ends of the YAG crystal 5a.

The first wavelength converting element 6 is an LBO (LiB₃O₅) crystal (nonlinear optical crystal), and the second wavelength converting element 7 is LB₄ (Li₂B₄O₇: lithium tetraborate single crystal) crystal (nonlinear optical crystal).

In the second wavelength converting element 7, a so-called walk-off phenomenon occurs that an input beam and a harmonic wave beam to be generated are divided in a nonlinear crystal with their walk-off angles by the birefringence of the crystal, and the beam profile (cross-sectional shape of a beam) of the harmonic wave beam is flattened in one direction. In addition, the LB₄ crystal used for the above second wavelength converting element 7 is excellent in chemical stability and laser damage resistance, is able to grow to large-sized crystals with an excellent quality by the CZ (Czochralski) method, etc., is excellent in machinability, and is easy to be made long.

The optical systems 3 includes mirrors 8a and 8b which change the optical path of the quadruple wave laser beam λ₄, an expander lens 9 which expands the beam diameter of the quadruple wave laser beam λ₄, a condenser lens 10 which focuses and irradiates the quadruple wave laser beam λ₄ whose beam diameter is expanded onto the surface of the workpiece 2, and a prism inserting/extracting mechanism 11 which causes the flattening direction to coincide with the direction of movement of the quadruple wave laser beam λ₄ changed by the moving mechanism 4.

In addition, the quadruple wave laser beam λ₄ irradiated onto the workpiece 2 via the optical system 3 has a beam profile that analogously coincides with the beam profile immediately after the emission from the laser head unit 1.

The moving mechanism 4, which is an XY stage mechanism which has a stepping motor, etc., and to which the workpiece 2 can be attached, is set so that the direction of movement of the quadruple wave laser beam λ₄ coincides with the flattening direction.

The prism inserting/extracting mechanism 11, which is a mechanism which can insert/extract a prism (Dove prism) 12 which changes the flattening direction onto/from the optical path of the quadruple wave laser beam λ₄, is composed of the prism 12, and a drive 13, such as a motor, which moves the prism 12. This prism inserting/extracting mechanism 11 is used to change the direction of grooving to a Y direction orthogonal to the X direction. Specifically, by driving the drive 13 to insert the prism 12 onto the optical path of the quadruple wave laser beam λ₄ (in the present embodiment, between the mirror 8a and the expander lens 9), the laser beam is focused in a state where the flattening direction rotates by 90° and the laser beam is flattened in an elliptical shape in the Y direction on the workpiece 2.

In this state, the moving mechanism 4 relatively moves the workpiece 2 in the Y direction to be grooved whereby the focused quadruple wave laser beam λ₄ moves in the direction (Y direction) of grooving which coincides with the flattening direction (Y direction), and grooving is performed also in the Y direction.

The control unit C is composed of an IC, a memory, etc., and has a function which controls the laser head unit 1 so that, as the preset and input machining depth of grooving or cutting is greater, or as the scanning speed of the quadruple wave laser beam λ₄ is higher, the pulse width of the quadruple wave laser beam λ₄ is made greater.

Moreover, the control unit C controls the laser head unit 1, the optical system 3, and the moving mechanism 4, respectively, so that the pulse width of the quadruple wave laser beam λ₄ may be set to 15 nsec or greater and the peak power density of the quadruple wave laser beam λ₄ may be set to 0.8 GW/cm² or less.

Next, the grooving method (laser beam machining method) of the workpiece 2 by the above laser beam machining apparatus will be described below with reference to FIG. 1.

First, in the laser head unit 1, the excitation light from the semiconductor laser LD enters the YAG laser 5 in pulses with a predetermined pulse width to generate a fundamental wave laser beam λ₁. Next, the fundamental wave laser beam λ₁ enters the first wavelength converting element 6 where it is converted into a double wave laser beam λ₂. Furthermore, the double wave laser beam λ₂ enters the second wavelength converting element 7 where it is converted to a quadruple wave laser beam λ₄, and is output. At this time, in the second wavelength converting element 7, the beam profile of the second harmonic wave beam generated by the walk-off phenomenon is flat in a specific direction.

The quadruple wave laser beam λ₄ emitted from the laser head unit 1 is finally irradiated and focused onto the workpiece 2 via the expander lens 9 and the condenser lens 10. At this time, the quadruple wave laser beam λ₄ is focused onto the workpiece 2, with a shape analogous to the beam profile when it is emitted from the laser head unit 1. Furthermore, the control unit C adjusts the expander lens 9 and the condenser lens 10 of the optical system 3 to set the peak power density of the quadruple wave laser beam λ₄ to 0.8 GW/cm² or less.

In the present embodiment, when the excitation light from the semiconductor laser LD enters the YAG laser 5 in pulses to generate a fundamental wave laser beam λ₁, the pulse width of the semiconductor laser LD is converted according to the groove depth of a groove to be machined and the scanning speed of the moving mechanism 4, and thereby the pulse width of the quadruple wave laser beam λ₄ that is a final irradiation beam is adjusted. That is, the control unit C adjust the laser head unit 1 to set the pulse width of the quadruple wave laser beam λ₄ according to the groove depth of a groove to be machined and the scanning speed that are input and set in advance so that, as the scanning speed is higher and as the groove depth of a groove to be machined is greater, the pulse width is made greater. For example, the semiconductor laser LD for excitation can change excitation intensity for CW radiation to adjust the pulse width to some degree. Furthermore, the length of a resonator may be changed to adjust the pulse width.

In addition, it is preferable to set the pulse width to 15 nsec or greater in order to sufficiently improve the machining ability.

As such, in the present embodiment, as the machining depth is greater or as the scanning speed is higher, the pulse width of the quadruple wave laser beam λ₄ is set to be greater. As a result, the machining ability can be significantly improved compared with a case where the average power is increased. In addition, even if the average power of the quadruple wave laser beam λ₄ is increased, there is little improvement in machining ability. It is believed that this is due to a shielding effect or the like that is caused by the plasma generated in the vicinity of the workpiece 2 during laser beam irradiation. However, in the present embodiment, it is considered that the influence by the generated plasma can be reduced and the machining ability can be significantly improved by increasing the pulse width of the quadruple wave laser beam λ₄.

In particular, in the present embodiment, the pulse width of the quadruple wave laser beam λ₄ is set to at least 15 nsec or greater, and the peak power density is set to 0.8 GW/cm² or less, so that, as shown in the data of the Examples to be described below, significant degradation of the cutting ability can be prevented and the machining ability can be improved sufficiently even in the same average power.

Furthermore, in the present embodiment, since the quadruple wave laser beam λ₄ (with a wavelength of 266 nm) by the first wavelength converting element 6 and the second wavelength converting element 7 is used, a high-energy and short-wavelength laser beam of 400 nm or less can be stably radiated by a small apparatus.

### EXAMPLES

In the laser beam machining according to the invention, the machining ability in a case where grooving was actually performed on an alumina substrate was investigated.

In this Example, as shown in Table 1, machining was performed by changing the scanning speed to 20, 50, and 100 mm/s to change the groove depth.

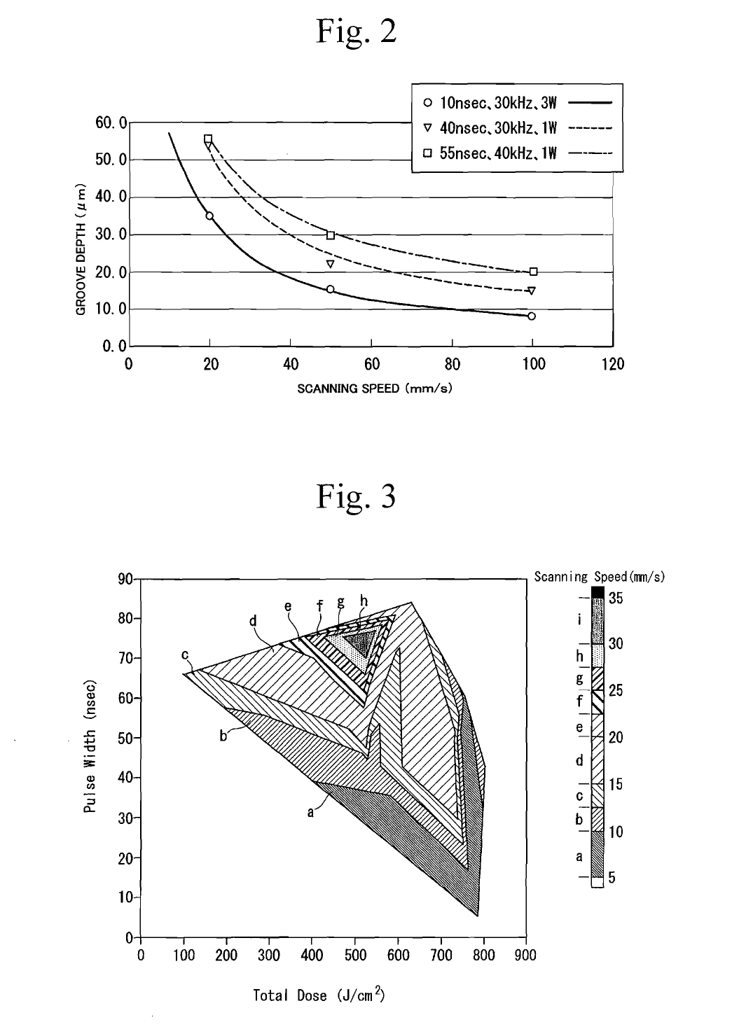

As the machining conditions, Example (1) in which the pulse width, the frequency, and the average power were set to 40 nsec, 30 kHz, and 1 W, respectively, and Example (2) in which the pulse width, the frequency, and the average power were set to 55 nsec, 40 kHz, and 1 W, respectively, were investigated. In addition, as conventional machining conditions, Comparative Example in which the pulse width, the frequency, and the average power were set to 10 nsec, 30 kHz, and 3 W, respectively, was investigated. The results thereof are shown in Table 1 and FIG. 2. In addition, the number of times of traces is set to two times in any of the above Examples.

TABLE 1

| | Comparative | | |
|---|---|---|---|
| | Example | Example (1) | Example (2) |
| | 10 nsec | 40 nsec | 55 nsec |
| Scanning Speed | 30 kHz | 30 kHz | 40 kHz |
| (mm/s) | 3 W | 1 W | 1 W |
| 20 | 35.0 | 54.9 | 56.7 |
| 50 | 15.6 | 55.6 | 59.7 |
| 100 | 8.3 | 15.5 | 20.7 |

(μm)

As shown in Table 1 and FIG. 2, it can be understood that, if the pulse width is increased to 40 nsec or 55 nsec even in a case where the average power is as small as 1 W, the machining ability (groove depth) of 1.5 times or greater is acquired at the scanning speed of 20 mm/s with respect to Comparative Example of 3 W in which the average power is set to 3 times.

Next, the result obtained by analyzing the laser beam scanning speed at which a constant groove depth (50 μm in this Example) can be achieved with respect to the total dose (pulse energy multiplied by overlapping degree of pulses) and the pulse width is shown in FIG. 3.

As can be understood from FIG. 3, as the pulse width is greater, the scanning speed is higher. That is, it can be understood that, as the pulse width is greater, the machining time can be shortened and the production cost can be lowered.

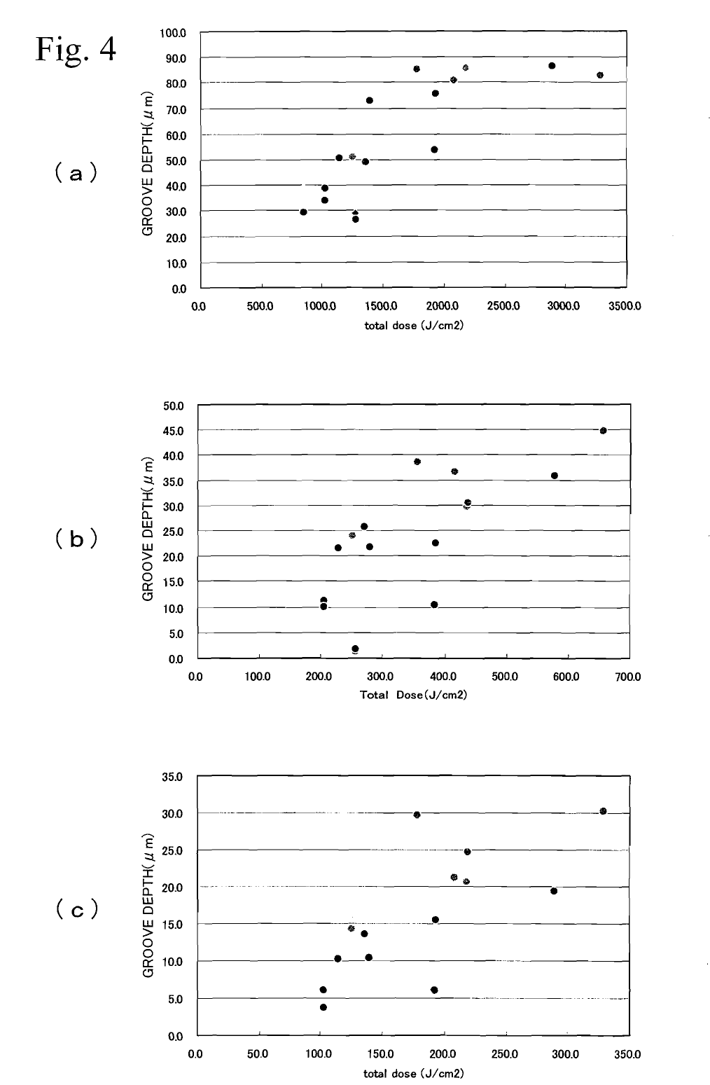

Next, the results obtained by analyzing the relationship between the total dose and the groove depth of a groove to be machined, the relationship between the pulse width and the groove depth, the relationship between the pulse width and the cutting ability (standard value showing how far a workpiece is hollowed per 1 pulse), and the relationship between the peak power density and the cutting ability in cases where the scanning speeds are 10 mm/s (a), 50 mm/s (b), and 100 mm/s (c), respectively, are shown in FIGS. 4A to 7C. In addition, in order to obtain these graphs, measurements were made under the machining conditions that not only the pulse width but the frequency and the average power are set to various values. In addition, the number of times of traces is set to two times in any of the above Examples.

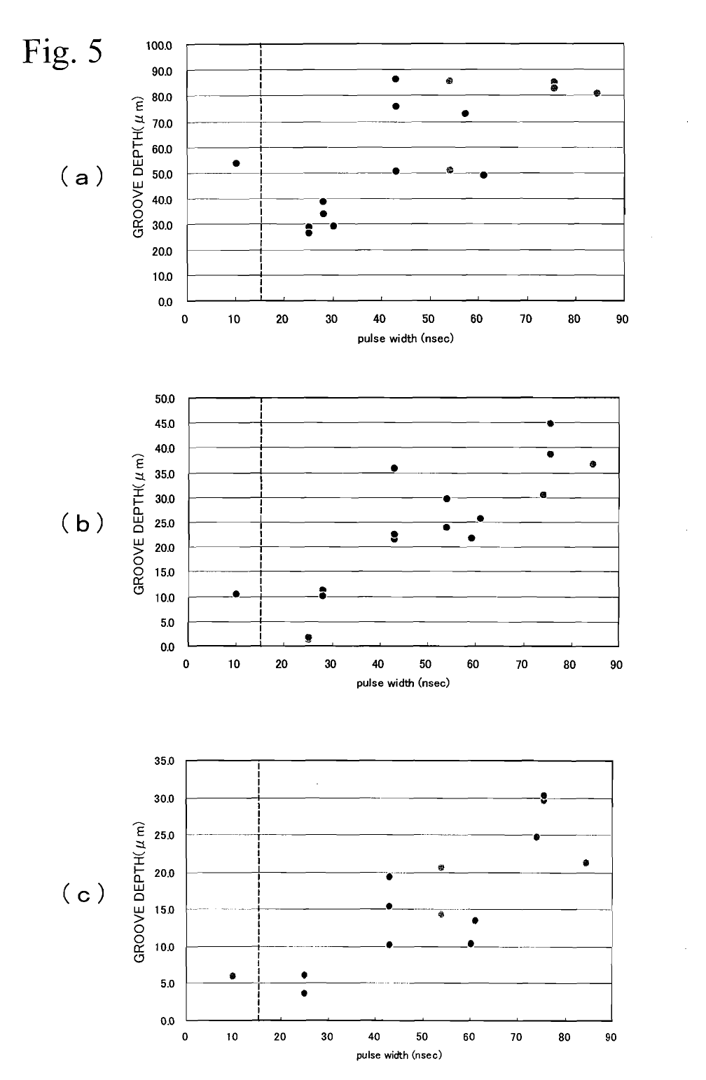

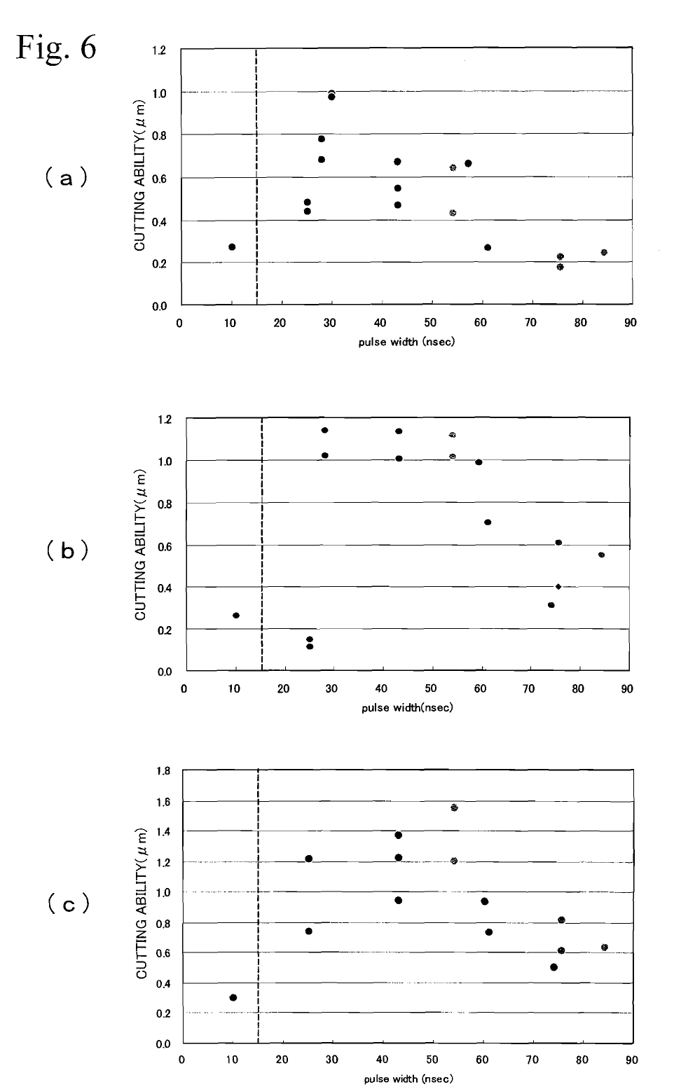

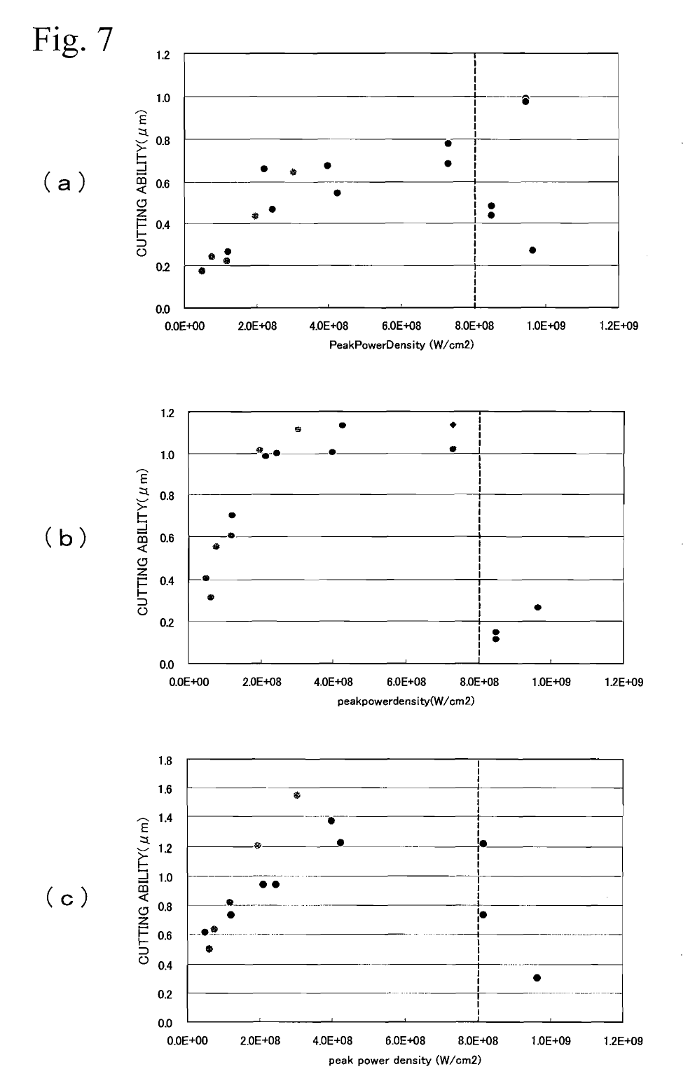

It can be understood from the relationship between the total dose and the groove depth and the relationship between the pulse width and the groove depth, as shown in FIGS. 4A to 5C, that, as the total dose is greater and as the pulse width is greater, the groove depth becomes greater. It can also be understood from the relationship between the pulse width and the cutting ability, as shown in FIGS. 6A to 6C, that a region where the cutting ability is improved exists. Moreover, it can be understood from the relationship between the peak power density and the cutting ability, as shown in FIGS. 7A to 7C, that, if the peak power density exceeds 0.8 GW/cm², the cutting ability degrades significantly.

It can be understood from the relationship between the pulse width and the groove depth and the relationship between the peak power density and the cutting ability that, if the pulse width is 15 nsec or greater, the machining ability can be improved sufficiently, and particularly if the peak power density is 0.8 GW/cm², a deep machined groove can be obtained by virtue of good cutting ability.

In addition, it is more advantageous to set the pulse width to be long if machining finish (the cross-sectional shape of a machined groove, the layer thickness after melting and rapid solidification, debris, etc.) is taken into consideration. Particularly when the machining speed is taken into consideration, it is preferable to set a long pulse width of 60 nsec or greater, a repeated high frequency of 50 kHz or greater, and an average power of 0.6 W or greater.

In addition, it should be understood that the technical scope of the invention is not limited to the above embodiments, but various modifications can be made without departing from the spirit and scope of the invention.

For example, as the nonlinear optical crystal used as the above first wavelength converting element 6 and second wavelength converting element 7, things other than LBO and LB₄, for example, BBO, (β-BaB₂O₄), KTP (KTiOPO₄), CLBO(CsLiB₆O₁₀), etc. may be used. In addition, as described above, the crystal that is easy to be made long like the LB₄ crystal of the above embodiment, and is possible to obtain both high conversion efficiency and beam transformation by walk-off is preferable. Furthermore, although an effect accompanying the walk-off is not obtained, a crystal in which the walk-off is not generated may be adopted.

Furthermore, although an Nd:YAG crystal is used as the host crystal, other host crystals, for example, Nd:YLF, etc. may be adopted.

Moreover, although the above embodiment has been described in conjunction with the case where the quadruple wave laser beam λ₄ is used, the same effect can be obtained even if a fivefold wave laser beam is used.

Furthermore, although the quadruple wave laser beam λ₄ with a wavelength of 266 nm is used, the same effect can be obtained if an ultraviolet laser beam with a wavelength of 400 nm or less, such as a wavelength of 355 nm, is used.

Furthermore, although the prism inserting/extracting mechanism 11 suitable for grooving is adopted in the above embodiment, the invention may be applied to apparatuses on which this mechanism is not mounted.

Furthermore, although an alumina substrate is machined as the workpiece 2, inorganic materials, such as sintered compact ceramics, silicon and other semiconductor substrates, sapphire and other oxide single crystal substrates, may be used as the workpiece.

1: A laser beam machining method comprising the steps of:
irradiating an ultraviolet laser beam in pulses onto a workpiece made of an inorganic material to groove or cut the workpiece, and
setting a pulse width of the ultraviolet laser beam greater as a scanning speed of the ultraviolet laser beam is higher, or as a machining depth of a grooving or a cutting is greater.

2: The laser beam machining method according to claim 1,
wherein the pulse width of the ultraviolet laser beam is set to 15 nsec or greater.

3: The laser beam machining method according to claim 2, further comprising the step of:
setting a peak power density of the ultraviolet laser beam is set to 0.8 GW/cm² or less.

4: The laser beam machining method according to claim 1,
wherein the ultraviolet laser beam is a harmonic laser beam whose wavelength is converted by causing a fundamental wave laser beam to enter a wavelength converting element made of a nonlinear optical crystal.

5: The laser beam machining method according to claim 1, further comprising the steps of:
generating the ultraviolet laser beam by a solid-state laser, and has a wavelength of 400 nm or less.

6: The laser beam machining method according to claim 5,
wherein at least Li₂B₄O₇ is used for the nonlinear optical crystal.

7: A laser beam machining apparatus for irradiating an ultraviolet laser beam in pulses onto a workpiece made of an inorganic material to groove or cut the workpiece, the apparatus comprising:
a laser light source unit which outputs the ultraviolet laser beam;
an optical system which focuses the ultraviolet laser beam to irradiate the workpiece with the ultraviolet laser beam;
a moving mechanism which relatively moves the ultraviolet laser beam to move a irradiation position in the workpiece; and
a control unit which controls the laser light source unit, the optical system, and the moving mechanism, respectively,
wherein the control unit set the pulse width of a ultraviolet laser beam to be long, as a scanning speed of the ultraviolet laser beam is higher, or as a machining depth of a grooving or a cutting is greater.

8: The laser beam machining apparatus according to claim 7,
wherein the control unit sets the pulse width of the ultraviolet laser beam to 15 nsec or greater.

9: The laser beam machining apparatus according to claim 8,
wherein the control unit sets a peak power density of the ultraviolet laser beam to 0.8 GW/cm² or less.

10: The laser beam machining apparatus according to claim 7,
wherein the ultraviolet laser beam is a harmonic laser beam whose wavelength is converted by causing a fundamental wave laser beam to enter a wavelength converting element made of a nonlinear optical crystal.

11: The laser beam machining apparatus according to claim 7,
wherein the ultraviolet laser beam is generated by a solid-state laser, and has a wavelength of 400 nm or less.

12: The laser beam machining apparatus according to claim 11,
wherein Li₂B₄O₇ is used for the nonlinear optical crystal.
